(19) United States
(12) Patent Application Publication
(10) Pub. No.: US 2023/0418445 A1
(43) Pub. Date: Dec. 28, 2023

(54) METHOD FOR MIGRATING DISPLAY ELEMENT ACROSS APPLICATIONS AND ELECTRONIC DEVICE

(71) Applicant: HUAWEI TECHNOLOGIES CO., LTD., SHENZHEN, GUANGDONG (CN)

(72) Inventors: Qiang LI, Hangzhou (CN); Zhiqi LI, Hangzhou (CN)

(21) Appl. No.: 18/039,196

(22) PCT Filed: Nov. 29, 2021
(86) PCT No.: PCT/CN2021/134123

§ 371 Date: May 26, 2023

(30) Foreign Application Priority Data
Nov. 30, 2020 (CN) 202011380975.3

(51) Int. Cl. G06F 3/04842; G06F 3/0486; G06F 9/451

(52) U.S. Cl. CPC G06F 3/04842; G06F 3/0486; G06F 9/451

(57) ABSTRACT

A method for migrating a display element across applications and an electronic device are disclosed and relate to the field of operating systems. The method includes: An application includes an application component and a plurality of display components. The application component and the display components are compiled independently, and each of the display components is compiled independently. When starting a first application, an electronic device starts a first application component and a target display element that correspond to the first application. When migration of the target display element to a second application is received, the first application component sends an identifier of the target display element to a second application component corresponding to the second application, and closes the target display element. The target display element is started by the second application component. When restarting the second application, the second application component starts the target display element.

### CROSS REFERENCE TO RELATED APPLICATION

This application is a national stage of International Application No. PCT/CN2021/134123, filed on Nov. 29, 2021, which claims priority to Chinese Patent Application No. 202011380975.3, filed on Nov. 30, 2020. Both of the aforementioned applications are hereby incorporated by reference in their entireties.

### TECHNICAL FIELD

This application relates to the field of operating systems, and in particular, to a method for migrating a display element across applications and an electronic device.

### BACKGROUND

In the terminal field, an application developer independently develops and compiles each application, generates an independent installation package of each application, and releases the installation package on an application market. After downloading an installation package of a required application from the application market, a terminal decompresses and installs the installation package. When the terminal runs each application, to be specific, runs each application in an independent process, stable running of each application is ensured.

However, because of this application mechanism of independent compiling and independent running, functional modules, page jump logic, and the like of each application are completely determined during development. A user cannot participate in orchestration of the functional modules in the application, and a personalized requirement of the user on the application cannot be satisfied.

### SUMMARY

This application provides a method for migrating a display element across applications and an electronic device, so that a user can implement a function of migrating a display component across applications, and a personalized requirement of the user on an application can be satisfied.

To achieve the foregoing objectives, embodiments of this application provide the following technical solutions.

According to a first aspect, a method for migrating a display element across applications is provided. The method includes: An electronic device displays a first interface of a first application and a second interface of a second application, where the first interface includes a target display element; the electronic device receives a first operation for the target display element; and the electronic device displays a third interface of the first application and a fourth interface of the second application in response to reception of the first operation, where the third interface does not include the target display element, and the fourth interface includes the target display element.

It can be learned that a user may perform the first operation to migrate the target display element in the first interface of the first application to the second interface of the second application. That is, an effect of cross-application display element migration is implemented. In other words, a user can freely assemble display components in an application when running the application, so that a personalized requirement of the user is satisfied. For example, a user may combine application functions frequently used by the user into an application. In this way, after the user starts the application, use requirements of the application functions of the user in most cases can be satisfied. For another example, in an application including a plurality of application functions, a user may switch a part of application functions to a version that the user likes, for example, switch a music player to a version developed by a vendor that the user likes. In this way, user experience of using the application by the user is improved.

In addition, the method in this application also helps an application developer focus on development of an independent single application function, so that development difficulty of the developer is greatly reduced and development workload is also reduced.

In a possible embodiment, that an electronic device displays a first interface of a first application and a second interface of a second application includes: The electronic device starts a first application component and a target display component, and starts a second application component, where the first application component includes an entry executable program of the first application and a configuration file, the configuration file of the first application component includes an identifier of the target display element, and the first application component does not include a page package of the target display element; the target display component includes the page package of the target display element; and the second application component includes an entry executable program of the second application and a configuration file, and the configuration file of the second application component does not include the identifier of the target display element or the page package of the target display element.

The entry executable program is program code that is first started when the application is started, for example, program code guided by a main function. The configuration file includes information such as a package name (namely, a package name of the application component), a version number, and an application icon of the application. The configuration file further includes information about one or more display components corresponding to a home page, namely, information about the one or more display components corresponding to one or more display elements included in the home page. The information about the display component includes a package name and a version number of the display component (or referred to as a package name and a version number of the display element). In some examples, the configuration file further includes information about another display component on which the home page depends. The another display component on which the home page depends is, for example, when the home page jumps to another page, a display component corresponding to a display element forming the another page.

The page package (namely, the target display component) of the target display element includes a resource file, a code file, and a configuration file. The resource file is a picture, an audio/video resource, a network link, or the like required for displaying the display element. For example, the resource file is stored in a res directory. The code file executes page code of control logic of the display component. For example, the code file is stored in a code.so directory. The configuration file includes a package name and a version number that are of the display component, and information about another display component on which the home page depends.

It can be learned from the foregoing descriptions that, a developer independently compiles and packs a file required for starting a display component and an entry package for starting an application, and also independently compiles and packs files required for different display components. Therefore, the solution of this application implements componentization of an application, so that a display component on one application can be migrated to another application, and display and running of another display component on each application are not affected.

In a possible embodiment, that the electronic device displays a third interface of the first application and a fourth interface of the second application in response to reception of the first operation, where the third interface does not include the target display element, and the fourth interface includes the target display element includes: The first application component sends the identifier of the target display element to the second application component; and the first application component closes the target display component; and the second application component starts the target display component based on the identifier of the target display element, and displays the target display element.

The first application component and the second application component are different processes, and data may be transferred through IPC communication. Therefore, an example embodiment of migrating a display element is provided.

In a possible embodiment, that the first application component sends the identifier of the target display element to the second application component includes: The first application component determines an identifier of the second application component based on the first operation; and the first application component sends the identifier of the target display element to the second application component based on the identifier of the second application component.

Therefore, an example embodiment of obtaining, by the first application component, the identifier of the second application component is provided.

In a possible embodiment, the first operation is an operation for dragging the target display element to the second interface of the second application and leaving a display screen, and that the first application component determines an identifier of the second application component based on the first operation includes: The first application component determines the identifier of the second application component based on a position of leaving the display screen.

In a possible embodiment, the identifier of the target display element includes a package name and/or a version number of the target display element.

In a possible embodiment, the identifier of the second application component includes a process identifier of the first application component.

In a possible embodiment, after the electronic device displays the third interface of the first application and the fourth interface of the second application, the configuration file of the first application component does not include the identifier of the target display element, and the configuration file of the second application component includes the identifier of the target display element.

In some examples, when a user indicates to migrate the target display element in the first interface of the first application to the second interface of the second application, the first application component modifies the configuration file and deletes the identifier of the target display element. The second application component modifies the configuration file, and adds the identifier of the target display element. In this way, when the first application is subsequently started, the target display element is no longer displayed, and when the second application is subsequently started, the target display element may be displayed. That is, assembly of the functional modules of the application is implemented.

In a possible embodiment, the first interface of the first application is a home page of the first application, and the method further includes: The electronic device exits the first application; the electronic device receives a second operation for starting the first application; and the electronic device displays the home page of the first application in response to reception of the second operation, where the home page of the first application does not include the target display element.

In a possible embodiment, the second interface of the second application is a home page of the second application, and the method further includes: The electronic device exits the second application; the electronic device receives a third operation for starting the second application; and the electronic device displays the home page of the second application in response to reception of the third operation, where the home page of the second application includes the target display element.

In a possible embodiment, the first interface of the first application is an application download list of an application market, and the target display element is an item in the application download list; and that the electronic device displays a third interface of the first application and a fourth interface of the second application in response to reception of the first operation, where the third interface does not include the target display element, and the fourth interface includes the target display element includes: The first application component determines an identifier of a second application element based on the first operation; and the first application component requests, based on the identifier of the target display element, to download and install an installation package of the target display element; the first application component sends the identifier of the target display element to the second application component based on the identifier of the second application component; and the second application component starts the target display component based on the identifier of the target display element, and displays the target display element.

Therefore, an example of selecting an application component that is not downloaded from an application market to assemble a customized application is provided.

According to a second aspect, an electronic device is provided. The electronic device includes a processor, a memory, and a touchscreen. The memory, the touchscreen, and the processor are coupled. The memory is configured to store computer program code, and the computer program code includes computer instructions. When the processor runs the computer instructions in the memory, the electronic device is enabled to perform the method according to any one of the foregoing aspects and the possible embodiments of the foregoing aspects.

According to a third aspect, an apparatus is provided. The apparatus is included in an electronic device, and the apparatus has a function of implementing behavior of the electronic device in any method according to the foregoing aspects and the possible embodiments. The function may be implemented by hardware, or may be implemented by hardware executing corresponding software. The hardware or the software includes at least one module or unit corresponding to the foregoing function, for example, a receiving module or unit, a display module or unit, and a processing module or unit.

According to a fourth aspect, a computer-readable storage medium is provided. The computer-readable storage medium includes computer instructions. When the computer instructions are run on a terminal, the terminal is enabled to perform the method according to any one of the foregoing aspects and the possible embodiments of the foregoing aspects.

According to a fifth aspect, a graphical user interface on an electronic device is provided. The electronic device includes a display, a camera, a memory, and one or more processors. The one or more processors are configured to execute one or more computer programs stored in the memory; and the graphical user interface includes a graphical user interface displayed when the electronic device performs the method according to any one of the foregoing aspects and the possible embodiments of the foregoing aspects.

According to a sixth aspect, a computer program product is provided. When the computer program product runs on a computer, the computer is enabled to perform the method according to any one of the foregoing aspects and the possible embodiments of the foregoing aspects.

According to a seventh aspect, a chip system is provided. The chip system includes a processor. When the processor executes instructions, the processor performs the method according to any one of the foregoing aspects and the possible embodiments of the foregoing aspects.

It can be understood that the electronic device, the apparatus, the computer-readable storage medium, the computer program product, the graphical user interface, and the chip system provided in the foregoing aspects are all applied to the corresponding methods provided above. Therefore, for beneficial effects that can be achieved by the electronic device, the apparatus, the computer-readable storage medium, the computer program product, the graphical user interface, and the chip system, refer to the beneficial effects in the corresponding methods provided above. Details are not described herein again.

### BRIEF DESCRIPTION OF DRAWINGS

FIG. 1 is a schematic diagram of a structure of an installation package of an application according to an embodiment of this application;

FIG. 2A is a schematic diagram of a hardware structure of an electronic device according to an embodiment of this application;

FIG. 2B is a schematic diagram of a software structure of an electronic device according to an embodiment of this application;

FIG. 3A is a schematic diagram of a display interface of an application according to an embodiment of this application;

FIG. 3B is a schematic diagram of a structure of a component tree according to an embodiment of this application;

FIG. 3C is a schematic diagram of a structure of another component tree according to an embodiment of this application;

FIG. 4A is a schematic flowchart of a display element migration method according to an embodiment of this application;

FIG. 4B is a schematic diagram of display interfaces of some electronic devices according to an embodiment of this application;

FIG. 4C is a schematic diagram of display interfaces of some other electronic devices according to an embodiment of this application;

FIG. 4D is a schematic diagram of display interfaces of some other electronic devices according to an embodiment of this application;

FIG. 5A is a schematic diagram of a display interface layout method according to an embodiment of this application;

FIG. 5B is a schematic diagram of quadrant division of a display interface of an application according to an embodiment of this application;

FIG. 5C is a schematic diagram of another display interface layout method according to an embodiment of this application;

FIG. 6 is a schematic flowchart of another display element migration method according to an embodiment of this application;

FIG. 7 is a schematic flowchart of another display element migration method according to an embodiment of this application;

FIG. 8A is a schematic diagram of display interfaces of some other electronic devices according to an embodiment of this application;

FIG. 8B is a schematic diagram of display interfaces of some other electronic devices according to an embodiment of this application; and

FIG. 9 is a schematic diagram of a structure of a chip system according to an embodiment of this application.

### DESCRIPTION OF EMBODIMENTS

In the descriptions of embodiments of this application, unless otherwise specified, “I” means “or”. For example, AB may represent A or B. In this specification, “and/or” describes only an association relationship between associated objects and represents that three relationships may exist. For example, A and/or B may represent the following three cases: Only A exists, both A and B exist, and only B exists.

The terms “first” and “second” mentioned below are merely intended for a purpose of description, and shall not be understood as an indication or implication of relative importance or implicit indication of a quantity of indicated technical features. Therefore, a feature limited by “first” or “second” may explicitly or implicitly include one or more features. In the description of embodiments of this application, unless otherwise specified, “a plurality of” means two or more than two.

In embodiments of this application, the word “example” or “for example” is used for representing giving an example, an illustration, or a description. Any embodiment or design scheme described as an “example” or with “for example” in embodiments of this application should not be explained as being more preferred or having more advantages than another embodiment or design scheme. Exactly, the word such as “example” or “for example” is intended to present a related concept in a specific manner.

An embodiment of this application provides an application componentization solution. To be specific, one application includes a plurality of independent functional modules, and the functional modules are interconnected through a universal interface. In this way, a developer or a user can obtain a personalized application by assembling the functional modules. For example, a display interface of an application may include a plurality of display elements. One display element corresponds to one display component, and each display component may run independently. The display element is a display unit in the display interface of the application, and includes a view control, a picture, a video, a text, or the like. The display component is a page package of the corresponding display element, and is a minimum display component-class component that has an interface.

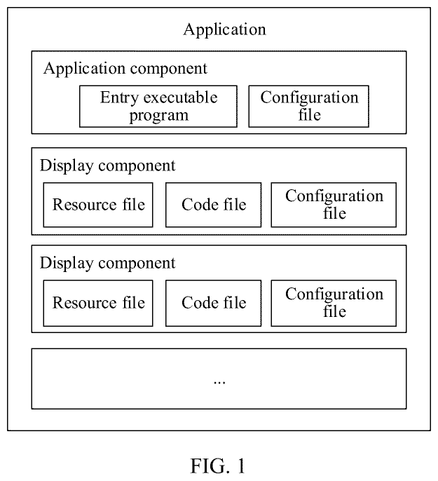

For example, FIG. 1 is a schematic diagram of a structure of an installation package of an application according to an embodiment of this application. Specifically, an installation package of an application includes an entry package (which may also be referred to as an application component corresponding to the application) and a page package (namely, a display component) including one or more display elements. It should be noted that the entry package and the page package of each display element are not coupled, the page packages of the display elements are not coupled, and the entry package and the page package of each display element are formed by independent compiling and packing. In other words, when designing and developing an application, a developer separately packs an entry program and a program of each page of the application into different installation packages.

Specifically, the foregoing entry package may include an entry executable program and a configuration file. The entry executable program is program code that is first started when the application is started, for example, program code guided by a main function. The configuration file includes information such as a package name (namely, a package name of the application component), a version number, and an application icon of the application. The configuration file further includes information about one or more display components corresponding to a home page, namely, the information about the one or more display components corresponding to one or more display elements included in the home page. The information about the display component includes a package name and a version number of the display component (or referred to as a package name and a version number of the display element). In some examples, the configuration file further includes information about another display component on which the home page depends. The another display component on which the home page depends is, for example, when the home page jumps to another page, a display component corresponding to a display element forming the another page.

A code example of a configuration file of an application component is provided as follows:

```
  {
      “package”:“application 1.huawei.homepage”, # Package name of
the application, which is globally unique
      “name”:“main”, # Entry executable file of the application
      “icon”:“launcher.png”, # Application icon
      “versionName”:“0.1”, # Application version number, which is of a
character string type
      “versionCode”:0, # Application version number, which is increased
      by an integer
      “size”:{
          “width”:1800, # Display width of the application component
          “height”:600 # Display height of the application component
      },
      “launcher”:true, # Whether the application is a launcher application
      “entry”:[ # Entry display component, namely, a display component
corresponding to a home page
          {
            “package”:“display component.huawei.home”, # Package
name of the entry display component
            “x”:0, # Default x coordinate of the display component
            “y”:0 # y coordinate of the started display component
          }
      ],
      “dependencies”:[ # Included display components, where all display
components of the current application may be listed
      {
            “package”:“display component.huawei.home”, #
Dependent display component package name
            “versionCode”:0 # Dependent component version
            number
      },
        {
            “package”:“display component.huawei.custom”, #
Dependent display component package name
            “uselastest”:1, # The dependent display component uses
the latest version by default
        }
      ]
    }
```

It should be noted that the entry package includes only information about a component that is to be displayed, and does not include a page package corresponding to the display component.

The page package of the display component includes a resource file, a code file, and a configuration file. The resource file is a picture, an audio/video resource, a network link, or the like required for displaying the display component. For example, the resource file is stored in a res directory. The code file executes page code of control logic of the display component. For example, the code file is stored in a code.so directory. The configuration file includes a package name and a version number that are of the display component, and information about another display component on which the home page depends.

A code example of a configuration file of a display component is provided as follows:

```
  {
    “package”:“display component.huawei.home”, # Display component
package name
    “versionName”:“0.1”, # Display component version number, which is
of a character string type
    “versionCode”:0, # Display component version number, which is
increased by an integer
  }
```

It should be noted that a file required for starting a display component and an entry package for starting an application are independently compiled and packed, and files required for different display components are also independently compiled and packed. Therefore, the solution of this application implements componentization of an application, so that a display component on one application can be migrated to another application, and display and running of another display component on each application are not affected.

The technical solutions provided in embodiments of this application can be applied to an electronic device in which an application is installed. For example, the electronic device in embodiments of this application may be a mobile phone, a tablet computer, a personal computer (PC), a personal digital assistant (PDA), a netbook, a wearable electronic device (such as a smart band or a smartwatch), an augmented reality (AR) device, a virtual reality (VR) device, a vehicle-mounted device, Vision, a smart car, a smart speaker, or a robot. A specific form of the electronic device is not specifically limited in this application.

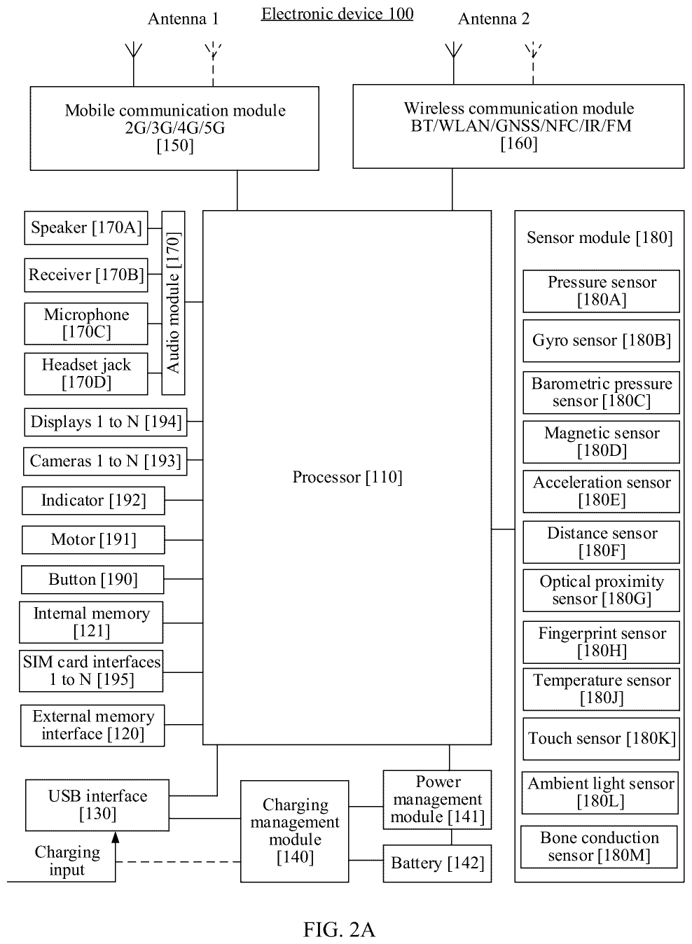

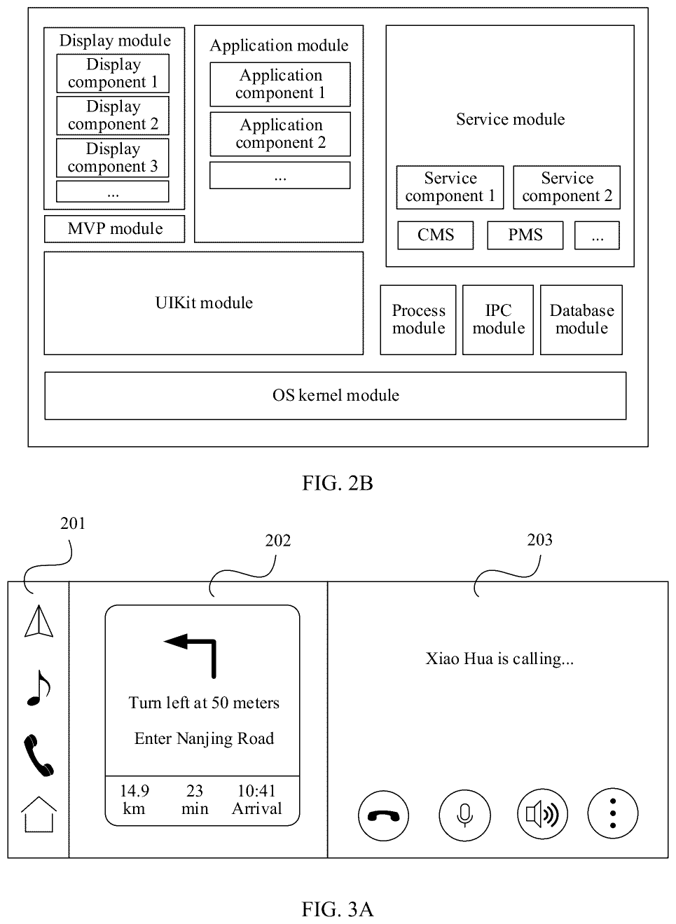

FIG. 2A is a schematic diagram of a structure of an electronic device 100 according to an embodiment of this application.

The electronic device 100 may include a processor 110, an external memory interface 120, an internal memory 121, a universal serial bus (USB) interface 130, a charging management module 140, a power management module 141, a battery 142, an antenna 1, an antenna 2, a mobile communication module 150, a wireless communication module 160, an audio module 170, a speaker 170A, a receiver 170B, a microphone 170C, a headset jack 170D, a sensor module 180, a button 190, a motor 191, an indicator 192, a camera 193, a display 194, a subscriber identity module (SIM) card interface 195, and the like. The sensor module 180 may include a pressure sensor 180A, a gyro sensor 180B, a barometric pressure sensor 180C, a magnetic sensor 180D, an acceleration sensor 180E, a distance sensor 180F, an optical proximity sensor 180G, a fingerprint sensor 180H, a temperature sensor 180J, a touch sensor 180K, an ambient light sensor 180L, a bone conduction sensor 180M, and the like.

It may be understood that the structure shown in this embodiment of the present disclosure does not constitute a specific limitation on the electronic device 100. In some other embodiments of this application, the electronic device 100 may include more or fewer components than those shown in the figure, or some components may be combined, or some components may be split, or different component arrangements may be used. The components shown in the figure may be implemented by hardware, software, or a combination of software and hardware.

The processor 110 may include one or more processing units. For example, the processor 110 may include an application processor (AP), a modem processor, a graphics processing unit (GPU), an image signal processor (ISP), a controller, a video codec, a digital signal processor (DSP), a baseband processor, a neural network processing unit (NPU), and/or the like. Different processing units may be independent components, or may be integrated into one or more processors.

A memory may be further disposed in the processor 110, and is configured to store instructions and data. In some embodiments, the memory in the processor 110 is a cache. The memory may store an instruction or data that has been used or cyclically used by the processor 110. If the processor 110 is to use the instruction or the data again, the processor may directly invoke the instruction or the data from the memory. This avoids repeated access and reduces waiting duration of the processor 110, so that system efficiency is improved.

The charging management module 140 is configured to receive a charging input from a charger. The charger may be a wireless charger or a wired charger. The power management module 141 is configured to connect to the battery 142, the charging management module 140, and the processor 110. The power management module 141 receives an input from the battery 142 and/or the charging management module 140, and supplies power to the processor 110, the internal memory 121, the display 194, the camera 193, the wireless communication module 160, and the like.

A wireless communication function of the electronic device 100 may be implemented by using the antenna 1, the antenna 2, the mobile communication module 150, the wireless communication module 160, the modem processor, the baseband processor, and the like.

The antenna 1 and the antenna 2 are configured to transmit and receive an electromagnetic wave signal. Each antenna in the electronic device 100 may be configured to cover one or more communication frequency bands. Different antennas may be further multiplexed, to improve antenna utilization. The mobile communication module 150 may provide a wireless communication solution that is applied to the electronic device 100 and that includes 2G/3G/4G/5G.

The modem processor may include a modulator and a demodulator. The modulator is configured to modulate a to-be-sent low-frequency baseband signal into a medium-high frequency signal. The demodulator is configured to demodulate a received electromagnetic wave signal into a low-frequency baseband signal. Then, the demodulator transmits the low-frequency baseband signal obtained through demodulation to the baseband processor for processing. The low-frequency baseband signal is processed by the baseband processor and then transmitted to the application processor. The application processor outputs a sound signal through an audio device (which is not limited to the speaker 170A, the receiver 170B, or the like), or displays an image or a video through the display 194.

The wireless communication module 160 may provide a wireless communication solution that is applied to the electronic device 100, and that includes a wireless local area network (WLAN) (for example, a wireless fidelity (Wi-Fi) network), Bluetooth (BT), a global navigation satellite system (GNSS), frequency modulation (FM), a near field communication (NFC) technology, an infrared (IR) technology, or the like.

In some embodiments, the antenna 1 and the mobile communication module 150 in the electronic device 100 are coupled, and the antenna 2 and the wireless communication module 160 in the electronic device 100 are coupled, so that the electronic device 100 can communicate with a network and another device by using a wireless communication technology.

The electronic device 100 may implement a display function through the GPU, the display 194, the application processor, and the like. The GPU is a microprocessor for image processing, and is connected to the display 194 and the application processor. The GPU is configured to: perform mathematical and geometric computation, and render an image. The processor 110 may include one or more GPUs, which execute program instructions to generate or change display information.

The electronic device 100 may implement a photographing function through the camera 193, the ISP, the video codec, the GPU, the display 194, the application processor, and the like.

The ISP is configured to process data fed back by the camera 193. The camera 193 is configured to capture a static image or a video. The digital signal processor is configured to process a digital signal, and may process another digital signal in addition to a digital image signal. For example, when the electronic device 100 selects a frequency, the digital signal processor is configured to perform Fourier transformation on frequency energy. The video codec is configured to compress or decompress a digital video. The electronic device 100 may support one or more video codecs. In this way, the electronic device 100 may play back or record videos in a plurality of coding formats, for example, moving picture experts group (MPEG)-1, MPEG-2, MPEG-3, and MPEG-4.

The NPU is a neural-network (NN) computation processor. The NPU quickly processes input information by referring to a structure of a biological neural network, for example, by referring to a mode of transmission between human brain neurons, and continuously performs self-learning. Applications such as intelligent cognition of the electronic device 100 may be implemented through the NPU, for example, image recognition, facial recognition, speech recognition, and text understanding.

The external memory interface 120 may be used for connecting to an external storage card, for example, a micro SD card, to extend a storage capability of the electronic device 100. The external storage card communicates with the processor 110 through the external memory interface 120, to implement a data storage function. For example, files such as music and videos are stored in the external storage card.

The internal memory 121 may be configured to store computer-executable program code. The executable program code includes instructions. The internal memory 121 may include a program storage area and a data storage area. The program storage area may store an operating system, an application required by at least one function (for example, a voice playing function or an image playing function), and the like. The data storage area may store data (such as audio data and an address book) created during use of the electronic device 100, and the like. In addition, the internal memory 121 may include a high-speed random access memory, and may further include a non-volatile memory, for example, at least one magnetic disk storage device, a flash memory device, or a universal flash storage (UFS). The processor 110 runs instructions stored in the internal memory 121 and/or instructions stored in the memory disposed in the processor, to perform various function applications and data processing of the electronic device 100.

The electronic device 100 may implement an audio function, for example, music playing and recording, through the audio module 170, the speaker 170A, the receiver 170B, the microphone 170C, the headset jack 170D, the application processor, and the like.

The audio module 170 is configured to convert digital audio information into an analog audio signal for output, and is also configured to convert an analog audio input into a digital audio signal. The audio module 170 may be further configured to code and decode an audio signal. The speaker 170A, also referred to as a “loudspeaker”, is configured to convert an audio electrical signal into a sound signal. The electronic device 100 may be used for listening to music or answer a call in a hands-free mode over the speaker 170A. The receiver 170B, also referred to as an “earpiece”, is configured to convert an electrical audio signal into a sound signal. When a call is answered or speech information is received through the electronic device 100, the receiver 170B may be put close to a human ear to listen to a voice. The microphone 170C, also referred to as a “mike” or a “mic”, is configured to convert a sound signal into an electrical signal. When making a call or sending voice information, a user may make a sound near the microphone 170C through the mouth of the user, to input a sound signal to the microphone 170C. The headset jack 170D is configured to connect to a wired headset.

The button 190 includes a power button, a volume button, and the like. The button 190 may be a mechanical button, or may be a touch-sensitive button. The electronic device 100 may receive a key input, and generate a key signal input related to a user setting and function control of the electronic device 100.

The motor 191 may generate a vibration prompt. The motor 191 may be configured to provide an incoming call vibration prompt and a touch vibration feedback. The indicator 192 may be an indicator light, and may be configured to indicate a charging status and a power change, or may be configured to indicate a message, a missed call, a notification, and the like. The SIM card interface 195 is configured to connect to a SIM card. The SIM card may be inserted into the SIM card interface 195 or removed from the SIM card interface 195, to implement contact with or separation from the electronic device 100. The electronic device 100 may support one or N SIM card interfaces, where N is a positive integer greater than 1.

Specifically, a software system of the electronic device 100 may use a layered architecture, an event-driven architecture, a microkernel architecture, a micro service architecture, or a cloud architecture. In embodiments of the present disclosure, a layered architecture is used as an example to describe a software structure of the electronic device 100.

FIG. 2B is a schematic block diagram of the software structure of the electronic device 100 according to an embodiment of the present disclosure. In a layered architecture, software is divided into several layers, and each layer has a clear role and task. The layers communicate with each other through a software interface.

A top layer of the electronic device 100 may include functional modules that are directly oriented to a developer and a user, such as an application module, a display module, and a service module.

The service module includes a plurality of independent service components (which may also be referred to as services for short), for example, a service component 1 and a service component 2. The service component is a background service application-type component that has no interface, and the service component exists independently in a form of a process during running. In the service components, there is a special service component: component manager service (CMS). The CMS is a dedicated system service component for managing all components (including an application component, a display component, and a service component) and is the first service component after a system is started.

In the service components, there is further an application package manager service (PMS), which is for managing downloading, installation, upgrade, and uninstallation of installation packages of all the components (including the display component, the application component, the service component, and the like). A life cycle of the PMS is also managed by the CMS.

The application module includes a plurality of application components, for example, an application component 1 and an application component 2. The application component is a foreground application-type component that provides an interface for an application. The application component exists independently in a form of a process during running, and a life cycle of the application component is managed by the CMS. In this application, one application corresponds to one application component, and a configuration file of the application component includes a package name, a version number, and the like of a display component corresponding to a home page of the application. There are one or more display components corresponding to the home page. In some other examples, the application component further includes a package name, a version number, and the like of a display component on which the home page of the application depends. The display component on which the home page depends is, for example, when the home page jumps to another page, a display component corresponding to the another page.

The display module includes a plurality of display components, for example, a display component 1, a display component 2, and a display component 3. The display component is a minimum display-type component that has an interface. In some examples, the display component may be hosted by an application component, to be specific, the display component may be mounted to the application component. As described above, the configuration file of the application component includes the package name and the version number of the display component. When an application component is started, a display component mounted to the application component is started. When an application component is closed, a display component mounted to the application component is also closed. In general, a life cycle of the display component is managed by the application component that acts as the host. However, when the display component is in a migration state, the life cycle of the display component may be managed by the CMS, and the CMS modifies a mounting relationship between the display component and the application component, so as to implement a cross-application migration function. In some other embodiments, the display component may not be hosted by the application component, and run independently.

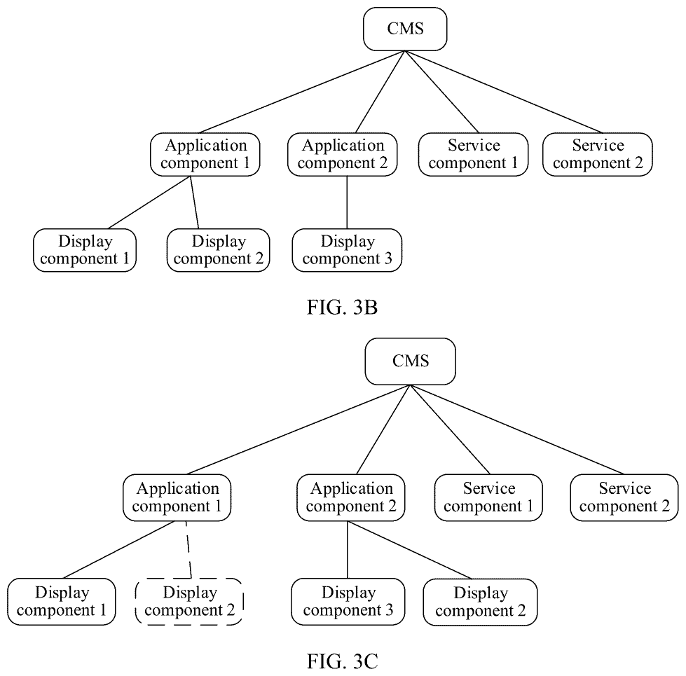

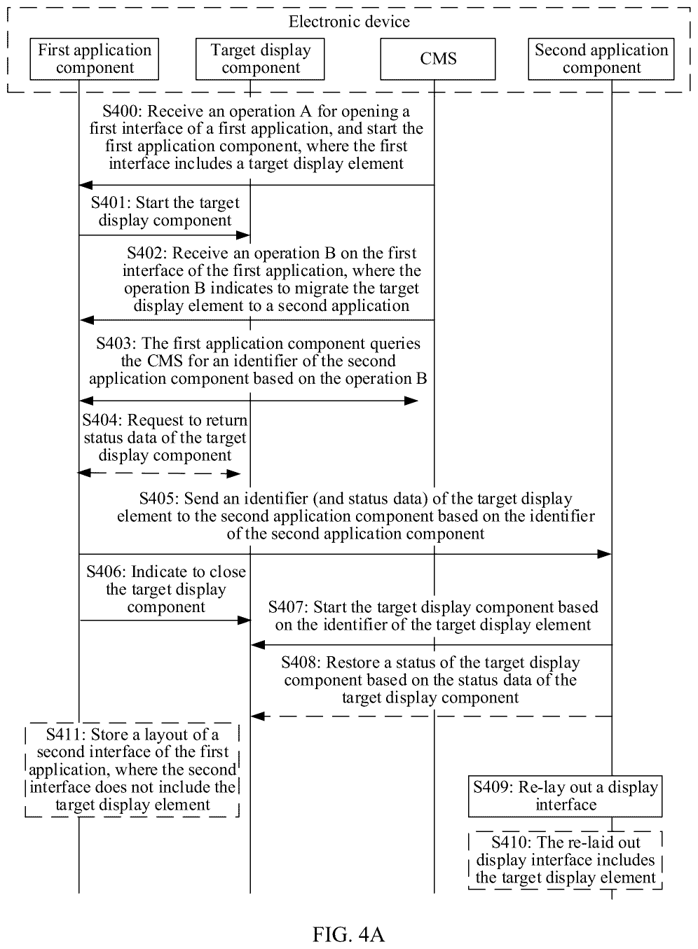

For example, the electronic device 100 is a vehicle head unit. FIG. 3A is an example of a display interface of a home page application of a vehicle head unit. The home page application includes one application component and three display components. The three display components respectively correspond to three display elements on a home page: a navigation bar 201, a driving navigation interface 202, and a call interface 203. To be specific, when the vehicle head unit starts the home page application, the application component is started, and each display component is separately started based on information about the display component in a configuration file of the application component, to separately display the navigation bar 201, the driving navigation interface 202, and the call interface 203. That is, the three display components are mounted to the application component.

It should be noted that some display components may be associated with some service components, that is, some display components may establish communication with some service components. For example, when displaying the driving navigation interface 202, the vehicle head unit may invoke a map service component and an audio service component. The map service component is configured to provide a positioning function, calculate a route between a current position and a destination, and the like. The audio service component is configured to play navigation voices. For another example, the vehicle head unit may invoke a call service component and an audio service component when displaying the call interface 203. The call service component is configured to provide a call function between the vehicle head unit and another terminal. The audio service component is configured to play user voices of the another terminal and pick up user voices of the local vehicle head unit.

The foregoing three display elements (the navigation bar 201, the driving navigation interface 202, and the call interface 203) correspond to independent modules of the display components and that are of each other. Therefore, an operation performed on any display component does not affect another display component.

For example, closing of the display component of the call interface 203 does not affect the navigation bar 201 and the driving navigation interface 202. Specifically, a system service component CMS of the vehicle head unit deletes a mounting relationship between the call interface 203 and the application component, but does not modify a mounting relationship between the navigation bar 201 and the application component and a mounting relationship between the driving navigation interface 202 and the application component. In addition, the CMS automatically closes service components (for example, the call service component and the audio service component) associated with the call interface 203.

When any one of the foregoing three display components is in a migration state, the system CMS of the vehicle head unit modifies a mounting relationship between the display component in the migration state and the application component. For example, when detecting that a user drags the application component on the call interface 203 to another application component (for example, an application component A), the CMS of the vehicle head unit stores related information of the call interface 203, and transfers the information to the application component A. The CMS closes the call interface 203 in the application component, and suspends the call service component and the audio service component that are associated with the call interface 203. Then, the CMS transfers information such as a package name and a version number of the call interface 203 to the application component A, and the application component A re-opens the call interface 203, and restores the call service component and the audio service component that are associated with the call interface 203. That is, the CMS changes the mounting relationship between the call interface 203 and the application component to a mounting relationship between the call interface 203 and the application component A. That is, the call interface 203 is migrated from the home page application to an application corresponding to the application component A. It should be noted that, at the same time, the navigation bar 201 and the driving navigation interface 202 are not affected by the migration of the call interface 203. An example migration procedure of the display component is described in detail below.

Back to FIG. 2B, an intermediate layer of the electronic device 200 may include a user interface framework (UIkit) module, a process module, an inter-process communication (IPC) module, a database module, and a model-view-presenter design (MVP) module. The UIkit module is configured to provide a basic graphic drawing function required for displaying an application. The process module is configured to provide a series of basic functions such as an application process, a thread, and process creation and destruction. The IPC module is configured to provide a function of exchanging data and signals between processes. The database module is configured to provide a required local persistent data storage function. The MVP module is configured to provide view display control and data control capabilities in an interface.

A bottom layer of the electronic device 200 includes an operating system kernel (OS Kernel) module, configured to provide an underlying running environment for an application framework.

To better understand the technical solutions provided in embodiments of this application, a management mechanism of the CMS for various components (including an application component, a display component, and a service component) in embodiments of this application is first described.

In some embodiments, the CMS may manage all components in an application by using a component tree. In other words, all the components in the application are displayed in the component tree when they are mounted, migrated, and uninstalled. In other words, the CMS maintains information about each component in the component tree. Information about an application component includes an identifier (for example, a package name, a version number, an application icon, or a process ID) of the application component, information about a display component included in the application component, a display area of an application, and the like. Information about a service component includes an identifier (for example, a package name, a version number, or a process ID) of the service component, a package name and a version number of an invoked application, and the like. Information about a display component includes information such as an identifier (for example, a package name and a version number) of the display component and an identifier of a host application component.

For example, FIG. 3B shows an example of a component tree. The root of the component tree is a service component CMS that manages all components. It can be learned from the figure that an electronic device runs an application component 1, an application component 2, a service component 1, and a service component 2. A display component 1 and a display component 2 are mounted to the application component 1. A display component 3 is mounted to the application component 2. It should be noted that the CMS can modify the mounting relationship of the display component. For example, as shown in FIG. 3C, the display component 2 originally mounted to the application component 1 is migrated to be mounted to the application component 2.

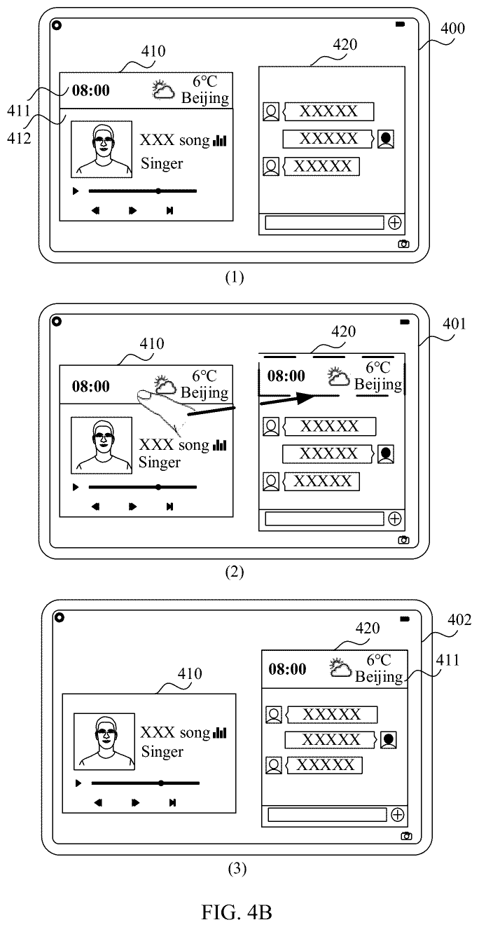

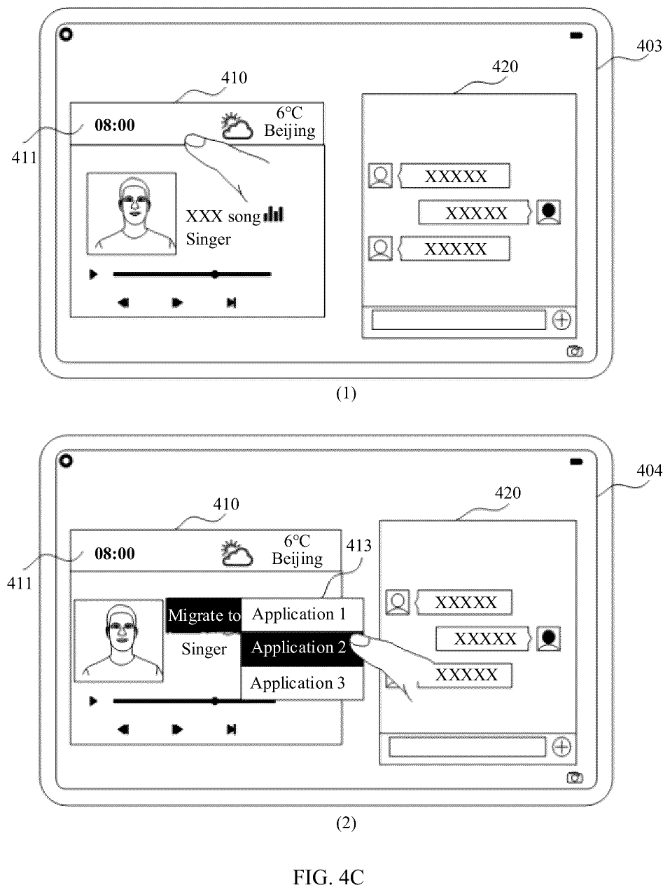

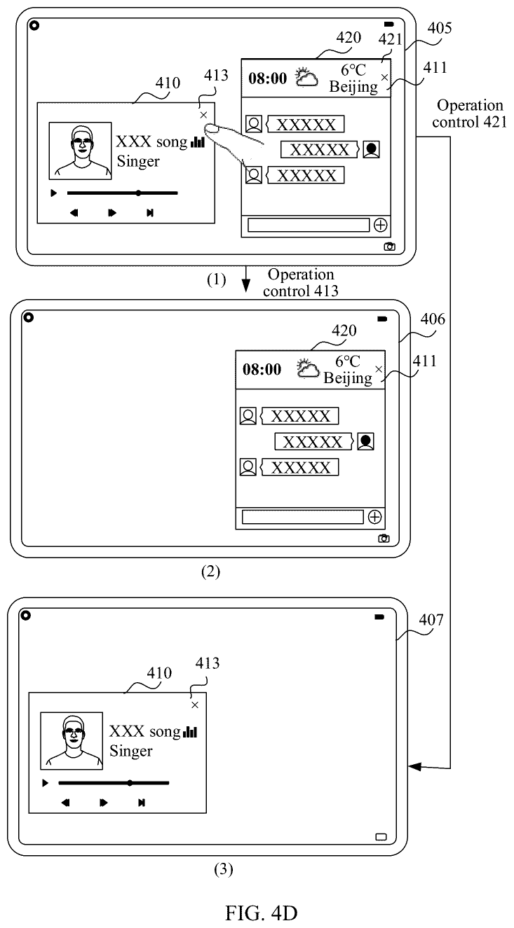

FIG. 4A is a schematic flowchart of a display element migration method according to an embodiment of this application. Details are as follows:
S400: An electronic device receives an operation A for opening a first interface of a first application, and starts a first application component of the electronic device. The first interface includes a target display element.
S401: The first application component indicates to start a target display component.

As described above, a package of the first application includes an entry package and a page package including one or more display components. The entry package may include an entry executable program and a configuration file. The configuration file further includes information about one or more display elements included in a home page. Each display element corresponds to one display component. In other words, the configuration file includes information about a display component that may be started when the home page is displayed. The information about the display component includes an identifier of the display element (which may also be considered as an identifier of the display component), for example, a package name and a version number. In some examples, the configuration file further includes information about another display component on which the home page depends. The another display component on which the home page depends is, for example, when the home page jumps to another page, a display component corresponding to a display element forming the another page.

In some examples, the first interface of the first application is the home page of the first application, and the operation A is an operation for starting the first application. The home page of the first application includes the target display element. In this case, the electronic device (which is the CMS for example) starts the first application after receiving the operation A. Specifically, the electronic device first runs the entry package corresponding to the first application, that is, starts the first application component. Then, a page package of a corresponding display element is executed based on the information about the display element included in the home page of the first application, where a page package for executing the target display element is included, that is, the target display component is started.

It should be noted that, in some other examples, the first interface of the first application is another interface of the first application. In other words, before receiving the operation A, the electronic device has started the first application, that is, has started the first application component. The operation A is an operation for jumping from an interface (the home page or a non-home page) that is currently displayed by the electronic device and that is of the first application to the first interface. The first interface includes the target display element. In this case, after receiving the operation A, the first application component executes a page package of a corresponding display component based on the information about the display component corresponding to the first interface of the first application, where the page package for executing the target display element is included, that is, the target display component is started.

After starting the target display component, the electronic device displays the first interface of the first application, and the first interface of the first application includes the target display element. For example, as shown in (1) in FIG. 4B, an interface 410 is an example of the first interface of the first application. The interface 410 may include two display elements, for example, a weather control 411 and a music playback control 412.
S402: The electronic device receives an operation B on the first interface of the first application, where the operation B indicates to migrate the target display element to a second application.

For example, the operation B may be an operation of a user for holding down the target display element on the first interface of the first application and dragging the target display element to a display interface of the second application. For example, before performing the operation B, the user may start the second application in advance. As shown in (1) in FIG. 4B, an interface 400 includes the interface 410 (the first interface of the first application) and an interface 420 (a first interface of the second application). An example in which the weather control 411 is the target display element is used for description. As shown in (2) in FIG. 4B, the operation B may be an operation of the user for holding down the weather control 411 and dragging the weather control 411 to the interface 420. In some examples, in a process in which a finger of the user drags the weather control 411, the weather control 411 moves along with dragging of the finger of the user on a screen.

For another example, the operation B may alternatively be a series of operations performed by a user. For example, before performing the operation B, the user may start the second application in advance. As shown in (1) in FIG. 4C, an interface 400 displayed by the electronic device includes the interface 410 (the first interface of the first application) and an interface 420 (a first interface of the second application). In some embodiments, the user alternatively does not start the second application in advance before performing the operation B, that is, the interface 400 may not include an interface 420. An example in which the weather control 411 is the target display element is used for description.

If the user performs an operation (for example, touching and holding or heavily pressing) on the weather control 411, the electronic device displays an option menu 413 shown in (2) in FIG. 4C, and prompts the user to select a target application to which the weather control 411 is to be migrated. In some examples, the option menu 413 may display a list of applications installed in the electronic device. In some other examples, the option menu 413 may display a list of applications that are started on the electronic device at this moment. This is not limited in embodiments of this application. Then, the user selects an option of “application 2” (namely, the second application). Herein, the operation B may include the operation performed for the weather control 411 and the operation for selecting the “application 2” option.

In an example embodiment, the electronic device (which is the CMS for example) sends received information about the operation B (a position of the operation B, and the like) to the first application component, so that the first application component obtains, based on the information about the operation B, an identifier of a second application component corresponding to the second application.
S403: The first application component queries the CMS for the identifier of the second application component based on the operation B.

For example, when the operation B is an operation for dragging the target display element, the electronic device monitors a position at which the finger of the user drags on the screen. When it is detected that the finger of the user leaves the screen (in this case, the user has dragged the target display element to the target application), a position of the finger on the screen before the finger leaves is recorded. The first application component reports the location to the CMS. As described above, the CMS can manage all components of each application by using a component tree. To be specific, the CMS maintains information about each component of each application, where the information includes an identifier (a package name, a version number, an application icon, and the like) of each component, a display area of the application, process information of each component, and the like. When the CMS finds that the position of the finger of the user before the finger leaves the screen is located in a display area of the second application, the CMS determines that the target application is the second application. Further, the identifier of the second application component (for example, which may be a process ID of the second application component) corresponding to the second application is returned to the first application component.

It should be noted that when finding that the position of the finger of the user before the finger leaves the screen covers display interfaces of two or more applications, the CMS determines a top-layer application as the target application.

It should be further noted that, similar to the first application, the second application includes one entry package and one or more page packages of one or more display components. When the second application is started, the second application component and a corresponding display component module may be started.

For another example, when the operation B is an operation for directly selecting the target application, the first application component may report an identifier (for example, a package name and a version number) of the selected target application to the CMS, and the CMS queries for the identifier of the second application component corresponding to the second application, and returns the identifier to the first application component.
S404: The first application component requests the target display component to return status data of the target display component. Correspondingly, the target display component returns the status data of the target display component to the first application component.

The status data of the target display component includes data during running of the target display component. For example, the target display component includes an audio/video player, and the status data of the target display component includes playback progress of an audio/video file. For another example, the target display component includes a document reader, and the status data of the target display component includes reading progress of a document. For another example, if the target display component includes a user input control, the status data of the target display component includes text information entered by the user, information about a selected option, and the like. In this way, when the target display element is migrated to the second application, and the target display component is re-started, the target display element can be quickly restored to a state during migration.

It should be noted that, in some other examples, the status data of the target display component may not be stored, that is, this operation is not performed. In this case, when the target display element is migrated to the second application, and the target display component is re-started, it is equivalent to that the target display component restores to an initial state.
S405: The first application component sends an identifier of the target display element to the second application component.

In operation S403, the first application component has obtained the identifier of the second application component, and then may communicate with the second application component by using the identifier of the second application component. It has been described above that the first application component starts the target display component based on the identifier of the target display element. Therefore, the identifier (for example, a package name or a version number) of the target display element is maintained in the first application component. In this case, the first application component sends the identifier of the target display element to the second application component, so that the second application component starts, based on the identifier of the target display element, the target display component corresponding to the target display element.
S406: The first application component indicates to close the target display component.

The first application component indicates to close the target display component. Specifically, the first application component receives a life cycle of the target display component, stops a process of the target display component created by the first application component, releases a memory resource occupied by the process, and the like. In this case, the electronic device displays a second interface of the first application, and the second interface of the first application does not include the target display element. For example, as shown in (3) in FIG. 4B, in the interface 402 displayed by the electronic device, the interface 410 is an example of the second interface of the first application, and the interface 410 does not include the weather control 411.

It should be noted that, before the second application component starts the target display component, the first application component closes the target display component started by the first application component. For example, in some examples, when the electronic device detects that a user touches and holds the target display element to starts to drag the target display element, the first application component may modify a display position of the target display element in real time based on a position at which a finger of the user touches a display screen during dragging. Then, the first application component renders the target display element in real time based on a modified display position of the target display element, so that the target display element moves along with dragging of the finger of the user on the screen. When detecting that the finger of the user leaves the display screen, the first application component closes the target display component, that is, the target display element is not displayed in a display interface of the first application. Alternatively, after performing operation S405, the first application component closes the target display component. Alternatively, before learning of the identifier of the target display element and determining that the target display component can be started, the second application component notifies the first application component. In this case, the first application component closes the target display component. In embodiments of this application, a specific occasion for closing the first application component is not limited.

In some other examples, if the second application component fails to start the target display component, the second application component may notify the first application component, and the first application component re-starts the target display component to display the target display element. It should be noted that in this case, the target display element is not migrated to the second application.

It should be noted that, in some examples, migrating the target display element from the first application is a one-time operation. That is, the first application component does not change the package of the first application (for example, the configuration file in the entry package). In this way, when the electronic device exits the first application and re-opens the first interface of the first application, the first interface of the first application still includes the target display element. In some other examples, after operation S406 is performed, the first application component may store the second interface of the first application by default or based on selection of the user (that is, operation S411 in the figure is performed). In an example embodiment, the first application component deletes information about the target display component (for example, the identifier of the target display element) from the configuration file of the entry package. In this case, when the electronic device exits the first application and re-opens the first interface of the first application, the electronic device displays the second interface of the first application, where the second interface does not include the target display element.
S407: The second application component starts the target display component based on the identifier of the target display element.

The identifier of the target display element includes the package name and/or the version number of the target display element. In this case, the second application component executes, based on the package name and/or the version number of the target display element, the page package corresponding to the target display element, that is, re-starts the target display component. In this case, the electronic device displays a second interface of the second application, where the second interface includes the target display element.
S408: The second application component restores a status of the target display component based on the status data of the target display component.

If the second application component further receives the status data of the target display component, the second application component may send the status data to the started target display component, to restore the status of the target display component before migration. If the second application component does not receive the status data of the target display component, this operation does not need to be performed.
S409: The second application component re-lay out the display interface.

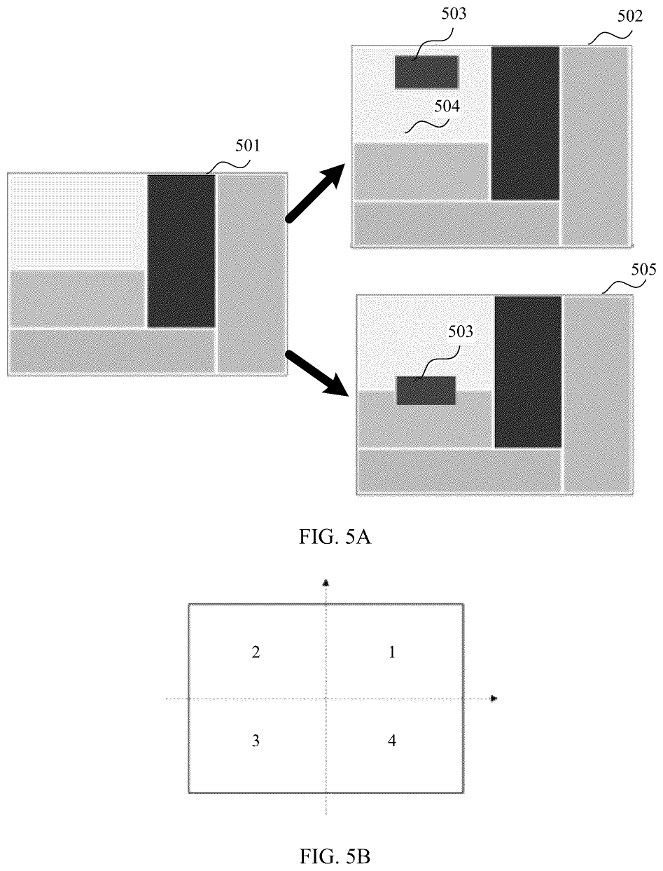

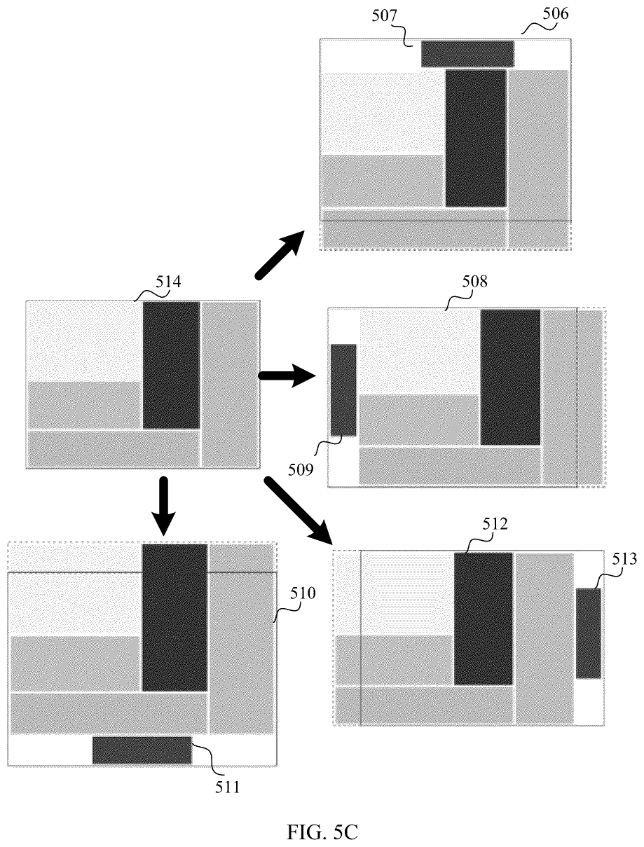

In some embodiments, the second application component determines a position of the target display element in the second interface of the second application based on a position specified by the user (for example, a position at which the user leaves the screen after dragging the target display element) or a default position (for example, a position at an edge of the display interface of the second application by default). For example, as shown in FIG. 5A, the first interface of the second application before migration is an interface 501, and includes five display components (a same color block in the figure is one display component). In this case, the target display element may cover a display component (for example, a display component 504) in the interface 501. In other words, the second interface of the second application is an interface 502. A display component 503 is the target display element. In an example, a life cycle of the newly added display component 503 may be consistent with that of the display component 504. Alternatively, the target display element may cover several display components in an interface 502. In other words, the second interface of the second application is an interface 505. In an example, a life cycle of the display component 503 may be independently controlled by the second application component, that is, the life cycle of the display component 503 is irrelevant to the covered display components.

For example, as shown in (3) in FIG. 4B, in the interface 402 displayed by the electronic device, the interface 420 is an example of the second interface of the second application, and the interface 420 includes the weather control 411.

In some other embodiments, the second application component determines a position of the target display element in the second interface of the second application based on a position specified by the user and with reference to the layout of the first interface of the second application.

For example, as shown in FIG. 5B, the first interface of the second application may be roughly divided into four quadrants: a quadrant 1, a quadrant 2, a quadrant 3, and a quadrant 4. Then, layout adjustment is performed on the second interface of the second application based on a quadrant in which the position specified by the user is located and a width-height relationship of the target display element.

As shown in FIG. 5C, the first interface of the second application is an interface 514. If the width of the target display element is greater than the height, and the user drags the target display element to the quadrant 1 or the quadrant 2 of the interface 514, the second interface of the second application may be an interface 506, where a display component 507 is the target display element. It can be learned that the original display component in the first interface of the second application is extended downward. In an example, the second interface of the second application keeps a display area the same as that of the first interface, and a part that exceeds the original display area may be viewed by scrolling a scroll bar. In another example, a display area of the second interface of the second application may be greater than a display area of the first interface. In this case, the second application component may have the CMS update a display area of the second interface after the re-layout.

For another example, if the width of the target display element is less than the height, and the user drags the target display element to the quadrant 2 or the quadrant 3 of the interface 514, the second interface of the second application may be an interface 508, where a display component 509 is the target display element. It can be learned that the original display component in the first interface of the second application is extended rightward. In an example, the second interface of the second application keeps a display area the same as that of the first interface, and a part that exceeds the original display area may be viewed by scrolling a scroll bar. In another example, a display area of the second interface of the second application may be greater than a display area of the first interface. In this case, the second application component may have the CMS update a display area of the second interface after the re-layout.

For another example, if the width of the target display element is greater than the height, and the user drags the target display element to the quadrant 3 or the quadrant 4 of the interface 514, the second interface of the second application may be an interface 510, where a display component 511 is the target display element. It can be learned that the original display component in the first interface of the second application is extended upward. In an example, the second interface of the second application keeps a display area the same as that of the first interface, and a part that exceeds the original display area may be viewed by scrolling a scroll bar. In another example, a display area of the second interface of the second application may be greater than a display area of the first interface. In this case, the second application component may have the CMS update a display area of the second interface after the re-layout.

For another example, if the width of the target display element is less than the height, and the user drags the target display element to the quadrant 1 or the quadrant 4 of the interface 514, the second interface of the second application may be an interface 513, where a display component 512 is the target display element. It can be learned that the original display component in the first interface of the second application is extended leftward. In an example, the second interface of the second application keeps a display area the same as that of the first interface, and a part that exceeds the original display area may be viewed by scrolling a scroll bar. In another example, a display area of the second interface of the second application may be greater than a display area of the first interface. In this case, the second application component may have the CMS update a display area of the second interface after the re-layout.

It should be noted that, in some examples, moving the target display element to the second application is a one-time operation. That is, the second application component does not change a package of the second application (for example, a configuration file in the entry package). In this way, when the electronic device exits the second application and re-opens the first interface of the second application, the first interface of the second application still does not include the target display element. In some other examples, the second application component may store the second interface of the second application by default or based on selection of the user (that is, operation S410 in the figure is performed). In an example embodiment, the second application component adds information about the target display element to the configuration file of the entry package. In this case, when the electronic device exits the second application and re-opens the first interface of the second application, the electronic device displays the second interface of the first application, where the second interface includes the target display element.

It should be further noted that after the target display element is migrated to the second application, a running status of the first application is irrelevant to the target display element. For example, as shown in (1) in FIG. 4D, in an interface 405, the interface 410 (namely, the second interface of the first application) further includes a close control 413. In response to an operation performed by the user on the close control 413, the electronic device displays an interface 406 shown in (2) in FIG. 4D. It can be learned that the electronic device closes the interface 410, but the weather control 411 does not change.

The target display element is related to a running status of the second application. For example, as shown in (1) in FIG. 4D, in the interface 405, the interface 420 (namely, the second interface of the second application) further includes a close control 421. In response to an operation performed by the user on the close control 421, the electronic device displays an interface 407 shown in (3) in FIG. 4D. It can be learned that the electronic device closes the interface 420, and the weather control 411 is not displayed. It should be noted that the interface 410 does not change.

It can be learned from the foregoing descriptions that, in embodiments of this application, display components in an application are decoupled, to implement a function of migrating a display component across applications. In this way, a user can freely assemble display components in an application when running the application, so that a personalized requirement of the user is satisfied. For example, a user may combine application functions frequently used by the user into an application. In this way, after the user starts the application, use requirements of the application functions of the user in most cases can be satisfied. For another example, in an application including a plurality of application functions, a user may switch a part of application functions to a version that the user likes, for example, switch a music player to a version developed by a vendor that the user likes. In this way, user experience of using the application by the user is improved.

In addition, the method in this application also helps an application developer focus on development of an independent single application function, so that development difficulty of the developer is greatly reduced and development workload is also reduced.

Further, in some embodiments, the information about the target display element may be retained in a configuration list of the first application component, and the information about the target display element may be newly added to a configuration list of the second application component. When the first application component is started, the first application component starts the target display element. When the second application component is started, the second application component starts the target display element. In other words, the first application component and the second application component may share the target display element, so as to implement resource sharing and capability sharing. In the conventional technology, if two applications both include a same functional module, the same functional module is equivalent to being downloaded twice, and occupies two pieces of storage space of the electronic device. However, in embodiments of this application, a plurality of applications may share one functional module (namely, a display component), to reduce traffic costs, time costs, and memory space for downloading.

It should be further noted that, in the foregoing embodiment, when the operation B is an operation that the user touches and holds the target display element in the interface of the first application and drags the target display element to the display interface of the second application, the target display element moves along with dragging of the finger of the user on the screen.

In an embodiment, as described in the foregoing embodiment, the first application component modifies the display position of the target display element in real time based on the position of the finger of the user on the screen. Then, the first application component renders the target display element in real time based on a modified display position of the target display element, so that the target display element moves along with dragging of the finger of the user on the screen.

In another embodiment, the first application component may alternatively start a snapshot display component, and the snapshot display component creates a snapshot of the target display element. Then, the snapshot of the target display element is moved, so that an effect that the target display element moves along with dragging of the finger of the user on the screen is achieved visually. Compared with real-time rendering of the target display element, the manner of rendering the snapshot of the target display element shortens required rendering duration, and is more convenient and quick.

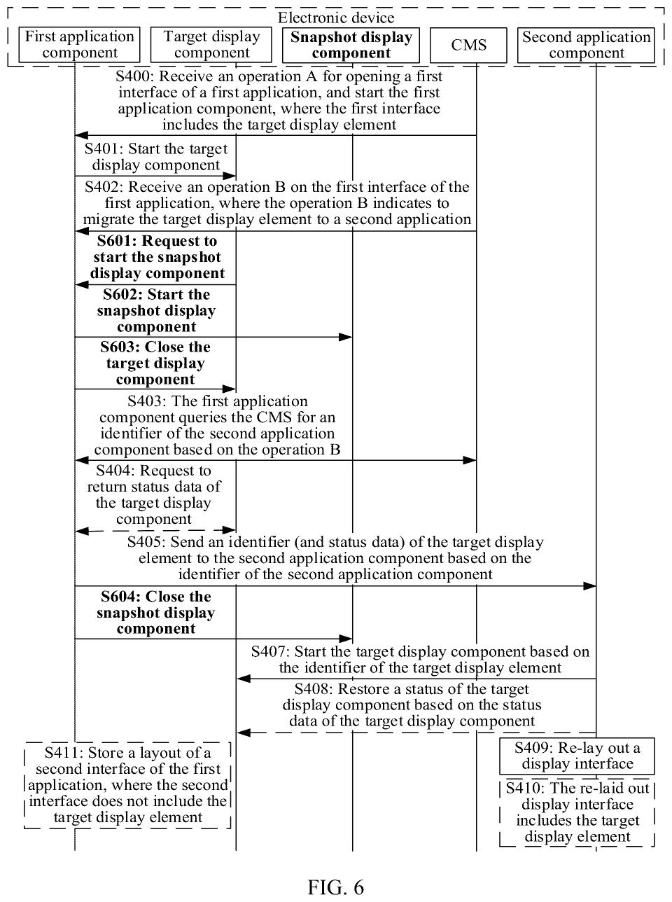

Specifically, FIG. 6 is a schematic flowchart of another display component migration method according to an embodiment of this application. Specifically, the method includes: operation S400 to operation S402, operation S601 to operation S603, operation S403 to operation S405, operation S604, and operation S407 to operation S411.

For operation S400 to operation S402, operation S403 to operation S405, and operation S407 to operation S411, refer to the descriptions of the foregoing related content. Details are not described herein again.
S601: The target display component requests the first application component to start the snapshot display component.
S602: The first application component starts the snapshot display component.
S603: The first application component closes the target display component.

When detecting that the user starts to perform the operation B in the first interface of the first application, the target display component may request the first application component to start the snapshot display component, and the snapshot display component creates a snapshot of the target display element. In addition, before the snapshot display component is started, the target display component may be closed. In other words, in this case, the electronic device may directly display the snapshot of the target display element. The user may observe that the snapshot of the target display element moves along with dragging of the finger of the user on the screen, to prompt the user that the operation B is being performed.

Similarly, after the first application component sends the identifier (and the status data) of the target display element to the second application component, that is, after operation S405 is performed, the first application component may perform operation S604, to be specific, close the snapshot display component. In other words, in this case, the electronic device does not display the snapshot of the target display element.

In the foregoing embodiment, the target display component is a display component downloaded by the electronic device. In some other embodiments, the target display component may alternatively be a display component that is not downloaded by the electronic device. An application includes a plurality of independent functional modules, for example, display components that are independent of each other and an application component. In this case, the application component and each display component may be independently downloaded, installed, updated, uninstalled, and the like. Therefore, the migrated target display component may alternatively be a display component that is not downloaded. For example, the target display component may be a display component displayed in an application list on an application market, and the display components may be display components that are not downloaded by the electronic device.

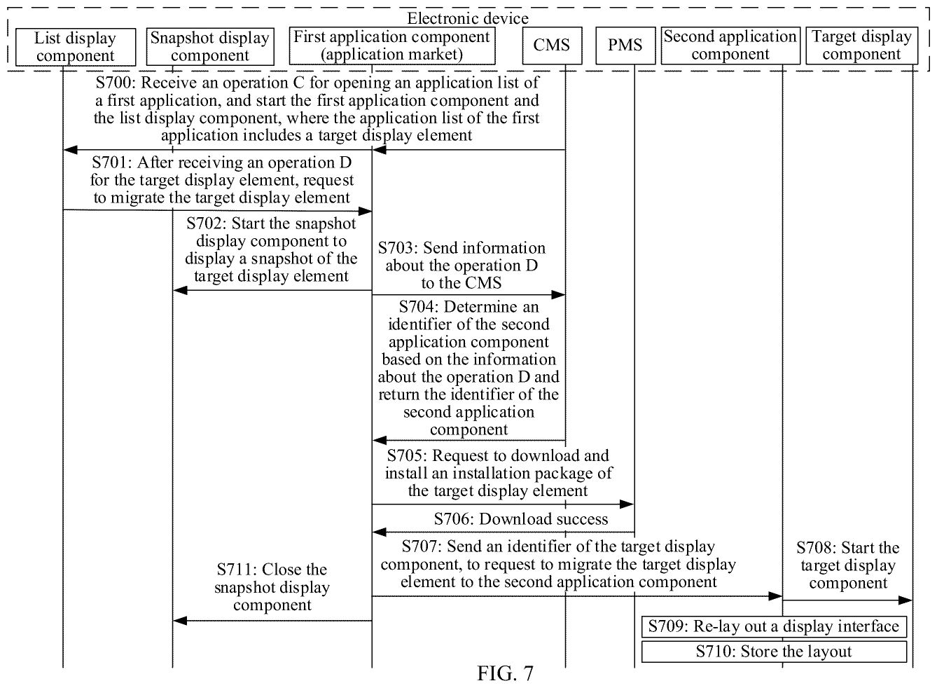

The following uses an application market as an example for description. FIG. 7 is a schematic flowchart of another display component migration method according to an embodiment of this application. Details are as follows:
S700: An electronic device receives an operation C for opening an application list of a first application, and starts a first application component and a list display component. The list display component includes a target display element.

The first application is, for example, an application market. The application market uses the componentization solution provided in embodiments of this application, to be specific, the application market includes a plurality of independent functional modules, for example, includes an application component (namely, the first application component) of the application market, the list display component, and another display component.

For example, a user may open the application market by tapping an application icon of the application market on the desktop of the electronic device. In some examples, a home page of the application market includes the application list. To be specific, a display component on which the home page of the application market depends includes the list display component. In this case, the electronic device (which may be a CMS for example) sequentially starts the first application component and the list display component. In this example, the operation C is an operation for opening the application market. In some other examples, the home page of the application market does not include the application list. To be specific, a display component on which the home page of the application market depends does not include the list display component. In this case, the electronic device (which may be a CMS for example) sequentially starts the first application component and the display component on which the home page depends. The user continues to perform one or more operations on the home page of the application market, so that the first application component starts the list display component, and the application market jumps from the home page to the application list. In this example, the operation C includes an operation for opening the application market, and one or more operations of jumping from the home page of the application market to the application list.

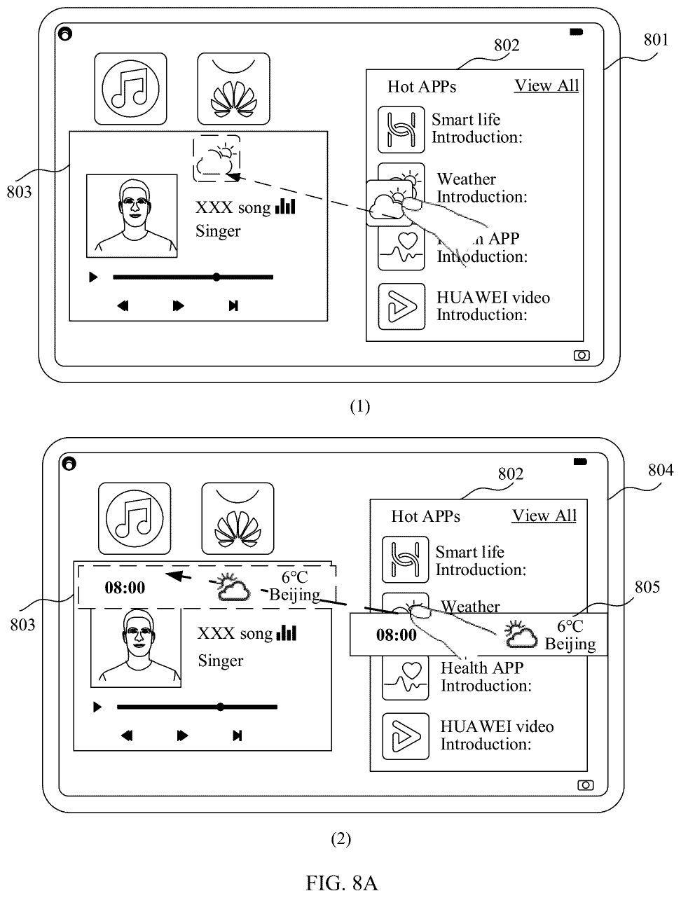

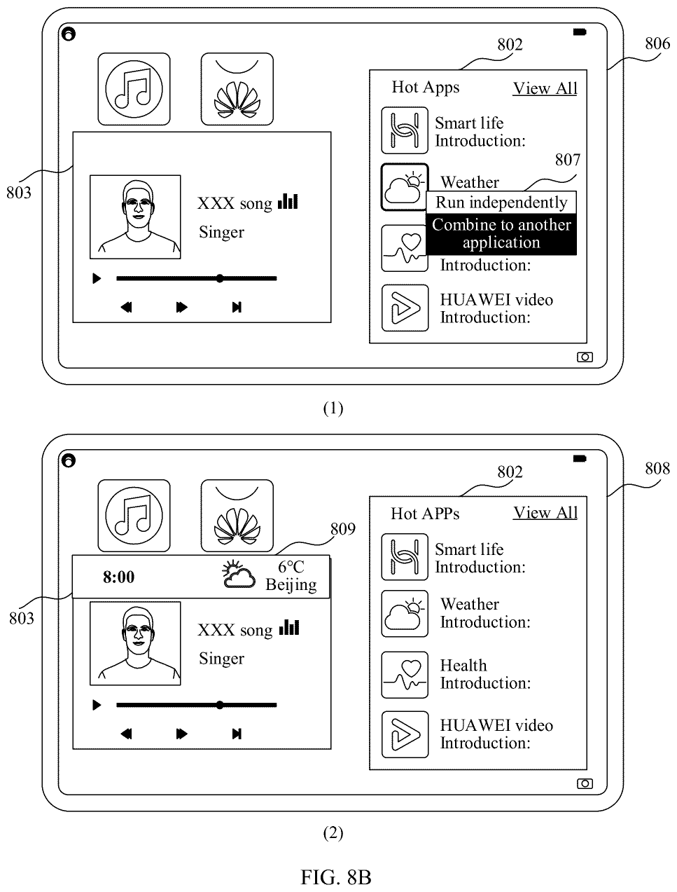

As shown in (1) in FIG. 8A, a display interface 801 of the electronic device includes an application list 802. The application list 802 displays a download list of a plurality of display components (or application components). Based on the foregoing descriptions of the componentization solution of the application, each display component may also be understood as an independent application, and an application component may also be understood as a display component corresponding to an application home page. In other words, display component migration provided in this application includes migration of a single display component, or may include overall migration of an application component including a plurality of display components.
S701: After receiving an operation D for the target display element, the list display component requests the first application component to migrate the target display element.

The operation D for the target display element is an operation for indicating to migrate the target display element.

For example, as shown in (1) in FIG. 8A, the operation D is touching and holding an icon of the target display element (for example, a weather display component) in the application list 802, and continuing to slide to a display interface of a second application while a finger does not leave a screen. A position of the icon of the target display element changes as the finger of the user drags on the screen. In this example, the operation D may be considered as a continuous sliding operation.

For another example, in an interface 804 shown in (2) in FIG. 8A, the operation D may alternatively be touching and holding, tapping, double tapping, or heavily pressing an icon of the target display element (for example, a weather display component) in the application list 802, the electronic device displays a snapshot 805 of the target display element, and a finger may leave or not leave a screen, and then slide to a display interface of a second application. A position of the snapshot 805 of the target display element changes as the finger of the user drags on the screen. In this example, the operation D may be considered as a continuous sliding operation, or may include a series of operations. For example, the operation D includes an operation for touching and holding, tapping, double tapping, or heavily pressing the icon of the target display element, and sliding to the display interface of the second application after the finger leaves the screen.

For another example, in an interface 806 shown in (1) in FIG. 8B, the operation D may alternatively be touching and holding, tapping, double tapping, or heavily pressing an icon of the target display element (for example, a weather display component) in the application list 802, and the electronic device displays options 807. If a user selects an option “Run independently”, the target display element is separately downloaded, and the target display element is installed and run as an independent application. If the user selects “Combine to another application”, the electronic device may display a snapshot of the target display element, and the user may touch and hold the snapshot of the target display element and drag the snapshot to a display interface of a second application. In this example, the operation D includes an operation for touching and holding, tapping, double-tapping, or heavily pressing the icon of the target display element, or the like, an operation for selecting “Combine to another application”, and an operation for dragging the snapshot of the target display element to the display interface of the second application.

It should be noted that a specific form of the operation D and an interface display on the electronic device are not specifically limited in embodiments of this application. The following uses an example in which the operation D is the operation shown in (2) in FIG. 8A for description.

In addition, it should be noted that the second application may also use the componentization solution provided in embodiments of this application, to be specific, the second application includes a second application component and another display component.

In an example embodiment, the user may perform the operation D for the target display element (for example, a weather display component) in the application list 802. After receiving the operation D for the target display element, the list display component requests the first application component to migrate the target display element. In an example, the request carries an identifier of the target display element, for example, a package name or a version number of the target display element. In another example, the request may alternatively carry an action position of the operation D. After receiving the action position of the operation D, the first application component may determine an identifier of the target display element based on the position.
S702: The first application component starts a snapshot display component to display a snapshot of the target display element.

For example, when it is detected that duration for which the user taps the icon of the target display element reaches a preset value (for example, 3 seconds), or pressure at which the user touches and holds the target display element reaches a preset pressure value, it is still considered that it is detected that the user starts to perform the operation D. When detecting that the user starts to perform the operation D, the first application component may start the snapshot display component, and the snapshot display component generates the snapshot of the target display element. It should be noted that the snapshot of the target display element herein may be a preset screenshot of a home page of the target display element. In other words, the snapshot display component may store a screenshot of a home page of each display component. When it is detected that the user performs the operation D for the target display element, the screenshot of the home page of the target display element may be directly displayed as the snapshot of the target display element. Then, a position of the snapshot of the target display element changes as the finger of the user drags on the screen.
S703: The first application component sends information about the operation D to the CMS.

After detecting that the user finishes performing the operation D, the first application component sends the information about the operation D (for example, a position at which the finger of the user leaves the screen, where the position is on the display interface of the second application) to the CMS, and the CMS may query, based on the information about the operation D, a target application to which the display component is to be migrated, namely, an identifier of the second application.
S704: The CMS determines an identifier of the second application component based on the information about the operation D and returns the identifier of the second application component to the first application component.

As described above, the CMS maintains information about all started application components, including identifiers, display areas, and the like of the application components. Therefore, the CMS may determine that the position at which the finger of the user leaves in the operation D is in a display area of the second application component, to determine the identifier of the second application component. The identifier may be, for example, a process ID of the second application component.
S705: The first application component requests a PMS to download a target display component.

It can be learned from the content descriptions in operation S701 that the first application component has learned of the identifier of the target display element, and includes the identifier of the target display element in a message for requesting the PMS to download the target display element.
S706: The PMS downloads the target display component based on the identifier of the target display element. After the downloading succeeds, a download success response is returned to the first application component.

In other embodiments, after receiving information indicating that the first application component requests to download the target display element, the PMS may first determine whether the target display component corresponding to the target display element has been downloaded or installed in the electronic device. If it is determined that the target display component has been downloaded or installed in the electronic device, the target display component may not be downloaded, and a response indicating that the target display component has been downloaded is directly returned to the second application component. It can be learned that when a plurality of applications are to use a same display component (with a same package name and a same version number), the display component may be downloaded only once, so that traffic costs and time costs of repeated downloading can be reduced, and memory space, in the electronic device, for storing an installation package of the display component can be reduced.
S707: The first application component sends the identifier of the target display element to the second application component, to request to migrate the target display element to the second application component.

It may be learned from the content descriptions in operation S704 that the first application component has learned of an identifier of the second application component (for example, a process ID of the second application component). The first application component may send a request to the second application component based on the identifier of the second application component, where the request carries an identifier (the package name and the version number) of the target display element.

In some embodiments, after sending the identifier of the target display element to the second application component, the first application component may indicate to close the snapshot display component, that is, operation S711 is performed.
S708: The second application component starts the target display component based on the identifier of the target display element.

After the target display component is started, the electronic device displays the target display element.
S709: The second application component re-lay out the display interface.

For a relationship between a display position of the target display element and the display interface of the second application during the re-layout, refer to the descriptions of the related content in operation S409. Details are not described herein again.

For example, in an interface 808 shown in (2) in FIG. 8B, a display interface 803 of the second application includes a target display element 809.
S710: The second application component stores the layout.

For example, the second application adds information about the target display element to a configuration file corresponding to the current display, for example, the identifier and the version number of the target display element. In this way, when the second application component exits the current interface and enters the interface again, the interface still includes the target display element.

In this way, a user may quickly download a new display component or application component by using an application market, and migrate the new display component or application component to a display interface of a target application, so that the user can quickly assemble a new application.

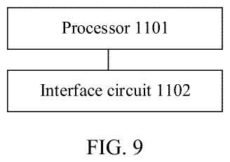

An embodiment of this application further provides a chip system. As shown in FIG. 9, the chip system includes at least one processor 1101 and at least one interface circuit 1102. The processor 1101 and the interface circuit 1102 may be interconnected through a line. For example, the interface circuit 1102 may be configured to receive a signal from another apparatus (for example, a memory of the electronic device 100). For another example, the interface circuit 1102 may be configured to send a signal to another apparatus (for example, the processor 1101). For example, the interface circuit 1102 may read instructions stored in the memory, and send the instructions to the processor 1101. When the instructions are executed by the processor 1101, an electronic device is enabled to perform operations performed by the electronic device 100 (for example, a mobile phone) in the foregoing embodiment. Certainly, the chip system may further include another discrete device. This is not specifically limited in this embodiment of this application.

An embodiment of this application further provides an apparatus. The apparatus is included in an electronic device, and the apparatus has a function of implementing behavior of the electronic device in any method in the foregoing embodiments. The function may be implemented by hardware, or may be implemented by hardware executing corresponding software. The hardware or the software includes at least one module or unit corresponding to the foregoing function, for example, a receiving module or unit, a display module or unit, and a processing module or unit.

An embodiment of this application further provides a computer storage medium, including computer instructions. When the computer instructions are run on an electronic device, the electronic device is enabled to perform any method in the foregoing embodiments.

An embodiment of this application further provides a computer program product. When the computer program product runs on a computer, the computer is enabled to perform any method in the foregoing embodiments.

An embodiment of this application further provides a graphical user interface on an electronic device. The electronic device includes a display, a camera, a memory, and one or more processors. The one or more processors are configured to execute one or more computer programs stored in the memory; and the graphical user interface includes a graphical user interface displayed when the electronic device performs any method in the foregoing embodiments.

It may be understood that to implement the foregoing functions, the terminal or the like includes corresponding hardware structures and/or software modules for performing the functions. A person skilled in the art should be easily aware that, in combination with the examples described in embodiments disclosed in this specification, units, algorithms, and operations may be implemented by hardware or a combination of hardware and computer software in embodiments of this application. Whether a function is performed by hardware or hardware driven by computer software depends on particular applications and design constraints of the technical solutions. A person skilled in the art may use different methods to implement the described functions for each particular application, but it should not be considered that the implementation goes beyond the scope of embodiments of the present disclosure.

In embodiments of this application, the terminal or the like may be divided into functional modules based on the foregoing method examples. For example, each functional module may be obtained through division based on each corresponding function, or two or more functions may be integrated into one processing module. The integrated module may be implemented in a form of hardware, or may be implemented in a form of a software functional module. It should be noted that in embodiments of the present disclosure, module division is an example, and is merely a logical function division. In some embodiments, another division manner may be used.

The foregoing descriptions about embodiments allow a person skilled in the art to clearly understand that, for the purpose of convenient and brief description, division of the foregoing functional modules is taken as an example for illustration. In actual application, the foregoing functions can be allocated to different modules and implemented according to a requirement, that is, an inner structure of an apparatus is divided into different functional modules to implement all or some of the functions described above. For a detailed working process of the foregoing system, apparatus, and unit, refer to a corresponding process in the foregoing method embodiments, and details are not described herein again.

Functional units in embodiments of this application may be integrated into one processing unit, or each of the units may exist alone physically, or two or more units are integrated into one unit. The integrated unit may be implemented in a form of hardware, or may be implemented in a form of a software functional unit.

When the integrated unit is implemented in the form of the software functional unit and sold or used as an independent product, the integrated unit may be stored in a computer-readable storage medium. Based on such an understanding, the technical solutions of this application essentially, or the part contributing to the conventional technology, or all or some of the technical solutions may be implemented in the form of a software product. The computer software product is stored in a storage medium and includes several instructions for instructing a computer device (which may be a personal computer, a server, or a network device) or a processor to perform all or some of the operations of the methods described in the embodiments of this application. The foregoing storage medium includes any medium that can store program code, such as a flash memory, a removable hard disk, a read-only memory, a random access memory, a magnetic disk, or an optical disc.

The foregoing descriptions are merely example embodiments of this application, but are not intended to limit the protection scope of this application. Any variation or replacement within the technical scope disclosed in this application shall fall within the protection scope of this application. Therefore, the protection scope of this application shall be subject to the protection scope of the claims.

1. A method comprising:
displaying, by an electronic device, a first interface of a first application and a second interface of a second application, wherein the first interface comprises a target display element;
receiving, by the electronic device, a first operation for the target display element; and
displaying, by the electronic device, a third interface of the first application and a fourth interface of the second application in response to the receiving of the first operation, wherein the third interface does not comprise the target display element, and the fourth interface comprises the target display element.

2. The method according to claim 1, wherein the displaying, by the electronic device, the first interface of the first application and the second interface of the second application comprises:
starting, by the electronic device, a first application component, a target display component, and a second application component,
wherein the first application component comprises an entry executable program of the first application and a configuration file, the configuration file of the first application component comprises an identifier of the target display element, and the first application component does not comprise a page package of the target display element,
wherein the target display component comprises the page package of the target display element, and
wherein the second application component comprises an entry executable program of the second application and a configuration file, and the configuration file of the second application component does not comprise the identifier of the target display element or the page package of the target display element.

3. The method according to claim 2, wherein the displaying, by the electronic device, the third interface of the first application and the fourth interface of the second application in response to the receiving of the first operation comprises:
sending, by the first application component, the identifier of the target display element to the second application component;
closing, by the first application component, the target display component; and
starting, by the second application component, the target display component based on the identifier of the target display element, and displaying the target display element.

4. The method according to claim 3, wherein the sending, by the first application component, the identifier of the target display element to the second application component comprises:
determining, by the first application component, an identifier of the second application component based on the first operation; and
sending, by the first application component, the identifier of the target display element to the second application component based on the identifier of the second application component.

5. The method according to claim 4, wherein the first operation is an operation for dragging the target display element to the second interface of the second application and leaving a display screen, and
wherein the determining, by the first application component, the identifier of the second application component based on the first operation comprises:
determining, by the first application component, the identifier of the second application component based on a position of leaving the display screen.

6. The method according to claim 3, wherein the identifier of the target display element comprises a package name and/or a version number of the target display element.

7. The method according to claim 4, wherein the identifier of the second application component comprises a process identifier of the first application component.

8. The method according to claim 2, wherein, after the electronic device displays the third interface of the first application and the fourth interface of the second application, the configuration file of the first application component does not comprise the identifier of the target display element, and the configuration file of the second application component comprises the identifier of the target display element.

9. The method according to claim 1, wherein the first interface of the first application comprises a home page of the first application, and the method further comprises:
exiting, by the electronic device, the first application;
receiving, by the electronic device, a second operation for starting the first application; and
displaying, by the electronic device, the home page of the first application in response to the receiving of the second operation, wherein the home page of the first application does not comprise the target display element.

10. The method according to claim 1, wherein the second interface of the second application comprises a home page of the second application, and the method further comprises:
exiting, by the electronic device, the second application;
receiving, by the electronic device, a third operation for starting the second application; and
displaying, by the electronic device, the home page of the second application in response to the receiving of the third operation, wherein the home page of the second application comprises the target display element.

11. The method according to claim 2, wherein the first interface of the first application comprises an application download list of an application market, and the target display element comprises an item in the application download list, and
wherein the displaying, by the electronic device, the third interface of the first application and the fourth interface of the second application in response to reception the receiving of the first operation comprises:
determining, by the first application component, the identifier of the target display element based on the first operation; and requesting, by the first application component based on the identifier of the target display element, to download and install an installation package of the target display element;
sending, by the first application component, the identifier of the target display element to the second application component based on the identifier of the second application component; and
starting, by the second application component, the target display component based on the identifier of the target display element, and displaying the target display element.

12. An electronic device, comprising a processor, a memory, and a touchscreen, wherein the memory, the touchscreen, and the processor are coupled, the memory is configured to store computer program code, the computer program code comprises computer instructions; and, in response to the processor running the computer instructions in the memory, the electronic device is enabled to perform operations comprising:
displaying, by the electronic device, a first interface of a first application and a second interface of a second application, wherein the first interface comprises a target display element;
receiving, by the electronic device, a first operation for the target display element; and
displaying, by the electronic device, a third interface of the first application and a fourth interface of the second application in response to the receiving of the first operation, wherein the third interface does not comprise the target display element, and the fourth interface comprises the target display element.

13. A computer-readable storage medium, comprising computer instructions, wherein, in response to the computer instructions running on an electronic device, the electronic device is enabled to perform operations comprising:
displaying, by the electronic device, a first interface of a first application and a second interface of a second application, wherein the first interface comprises a target display element;
receiving, by the electronic device, a first operation for the target display element; and
displaying, by the electronic device, a third interface of the first application and a fourth interface of the second application in response to the receiving of the first operation, wherein the third interface does not comprise the target display element, and the fourth interface comprises the target display element.

14. (canceled)

15. The electronic device according to claim 12, wherein the operations further comprise:
starting, by the electronic device, a first application component, a target display component, and a second application component,
wherein the first application component comprises an entry executable program of the first application and a configuration file, the configuration file of the first application component comprises an identifier of the target display element, and the first application component does not comprise a page package of the target display element,
wherein the target display component comprises the page package of the target display element, and
wherein the second application component comprises an entry executable program of the second application and a configuration file, and the configuration file of the second application component does not comprise the identifier of the target display element or the page package of the target display element.

16. The electronic device according to claim 15, wherein the displaying, by the electronic device, the third interface of the first application and the fourth interface of the second application in response to the receiving of the first operation comprises:
sending, by the first application component, the identifier of the target display element to the second application component;
closing, by the first application component, the target display component; and
starting, by the second application component, the target display component based on the identifier of the target display element, and displaying the target display element.

17. The electronic device according to claim 16, wherein the sending, by the first application component, the identifier of the target display element to the second application component comprises:
determining, by the first application component, an identifier of the second application component based on the first operation; and
sending, by the first application component, the identifier of the target display element to the second application component based on the identifier of the second application component.

18. The electronic device according to claim 17, wherein the first operation is an operation for dragging the target display element to the second interface of the second application and leaving a display screen, and
wherein the determining, by the first application component, the identifier of the second application component based on the first operation comprises:
determining, by the first application component, the identifier of the second application component based on a position of leaving the display screen.

19. The computer-readable storage medium according to claim 13, wherein the operations further comprise:
starting, by the electronic device, a first application component, a target display component, and a second application component,
wherein the first application component comprises an entry executable program of the first application and a configuration file, the configuration file of the first application component comprises an identifier of the target display element, and the first application component does not comprise a page package of the target display element,
wherein the target display component comprises the page package of the target display element; and
wherein the second application component comprises an entry executable program of the second application and a configuration file, and the configuration file of the second application component does not comprise the identifier of the target display element or the page package of the target display element.

20. The computer-readable storage medium according to claim 19, wherein the displaying, by the electronic device, the third interface of the first application and the fourth interface of the second application in response to the receiving of the first operation comprises:
sending, by the first application component, the identifier of the target display element to the second application component;
closing, by the first application component, the target display component; and
starting, by the second application component, the target display component based on the identifier of the target display element, and displaying the target display element.

21. The computer-readable storage medium according to claim 20, wherein the sending, by the first application component, the identifier of the target display element to the second application component comprises:
determining, by the first application component, an identifier of the second application component based on the first operation; and
sending, by the first application component, the identifier of the target display element to the second application component based on the identifier of the second application component.
